(19) United States
(12) Patent Application Publication
(10) Pub. No.: US 2014/0164139 A1
(43) Pub. Date: Jun. 12, 2014

(54) METHODS AND SYSTEMS FOR TARGETING USERS WITH AUDIO ADVERTISEMENTS

(71) Applicant: YAHOO! INC., Sunnyvale, CA (US)

(72) Inventor: Kiran B. LONIKAR, Bangalore (IN)

(73) Assignee: YAHOO! INC., Sunnyvale, CA (US)

(21) Appl. No.: 13/712,458

(22) Filed: Dec. 12, 2012

(51) Int. Cl. G06Q 30/02

(52) U.S. Cl. CPC G06Q 30/0251
USPC 705/14.66; 705/14.49

(57) ABSTRACT

Methods and systems for providing audio advertisements to client devices are disclosed. A request for an advertisement may be received at a server computer from a software library on a client device. The request may include one or more targeting criteria. An advertisement may be selected based at least in part on the one or more targeting criteria. The advertisement may be configured as text data. The text data may be encoded using speech synthesis markup language (SSML). The advertisement may be transmitted to the client device from the server computer. The software library may be configured to convert the text data to synthesized sound, and output the sound from the client device. The software library may include a text-to-speech (TTS) software module, which may convert the text data into synthesized sound, and output the sound from the client device.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

One particular target audience of interest to advertisers is users of mobile devices. Sales of internet-enabled mobile devices, such as smartphones, tablets, netbooks, laptops, etc. have experienced tremendous growth over the last few years. What's more, sales of mobile devices are projected to grow even further in the coming years.

However, advertising on mobile device platforms has several limitations partly due to the small screen size. Other possible reasons are limited network bandwidth over which advertisements can be delivered to the end user, and limited computing power on the mobile device. Thus, advertising on mobile platforms has remained limited and has not been exploited much despite the vast revenue generating potential that exists for mobile advertisements.

There is a need for improved techniques in targeting users of mobile devices with advertisements.

### SUMMARY

Some embodiments of the invention provide systems and methods for providing audio advertisements to client devices. In one embodiment, a request for an advertisement may be received at a server computer from a software library on a client device. The request may include one or more targeting criteria. The targeting criteria may be based on behavioral targeting and/or may be based on factors like user preferences, geographic location information, demographics (such as age, gender, etc.), contextual web page content, etc. The user preferences may include for example, language, types of advertisements (e.g., user may specify that he only wants to receive sports related advertisements), etc. In one embodiment, the software library may periodically send requests for advertisements to the server computer (e.g., every hour). The software library may retrieve targeting criteria from the client device, or may retrieve the targeting criteria from a third party source. The software library may transmit the targeting criteria along with the request for an advertisement to the server computer. In another embodiment, the software library may send requests for advertisements to the server computer at predetermined events. For example, a request may be sent when the user is at home, or when the client device is connected to Wi-Fi, etc.

An advertisement may be selected based at least in part on the one or more targeting criteria. The advertisement may be configured as text data. In one embodiment, the text data may be encoded using speech synthesis markup language (SSML). In another embodiment, the text data may be plain text data.

The advertisement may be transmitted to the client device from the server computer. In one embodiment, the software library is configured to convert the text data to synthesized sound, and the sound is output from the client device. The software library may include a text-to-speech (TTS) software module, which may convert the text data into synthesized sound, and output the sound from, for example speakers on the client device. Transmitting the advertisement(s) as text data advantageously consumes less bandwidth, and does not occupy valuable screen space on the client device. In one embodiment, the software library may display a prompt to obtain the user's permission before playing the synthesized sound. In another embodiment, the software library may also display a pop-up or other notification including a URL associated with the advertisement. The user may click the URL and be directed to the advertiser's website. In another embodiment, the software library may output the synthesized sound at a predetermined time, such as for example, at 8 PM, every night.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 is an exemplary distributed computer system according to one embodiment of the invention;

FIG. 2 is an exemplary schematic diagram illustrating a client device according to one embodiment of the invention;

FIG. 3 is an exemplary flowchart diagram according to one embodiment of the invention;

FIG. 4 is an exemplary flowchart diagram according to one embodiment of the invention; and

FIG. 5 is an exemplary block diagram illustrating one embodiment of the invention.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

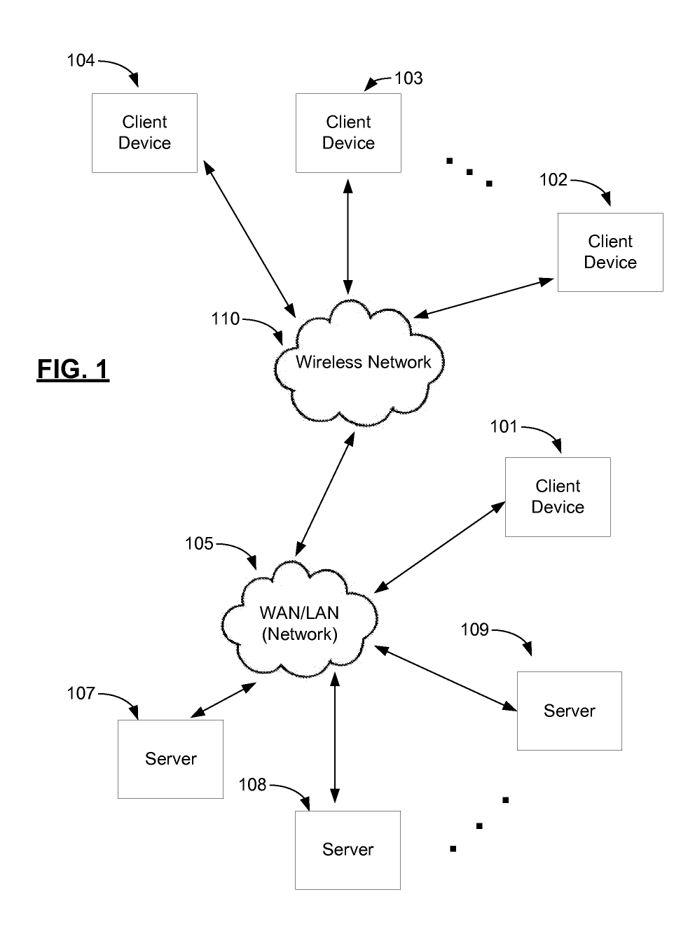

FIG. 1 is a schematic diagram illustrating one embodiment of an environment in which the invention may be practiced. Not all the components may be required to practice various embodiments, and variations in the arrangement and type of the components may be made. As shown, system 100 of FIG. 1 includes local area networks (“LANs”)/wide area networks (“WANs”)-(network) 105, wireless network 110, client devices 101-104, and server computers 107-109.

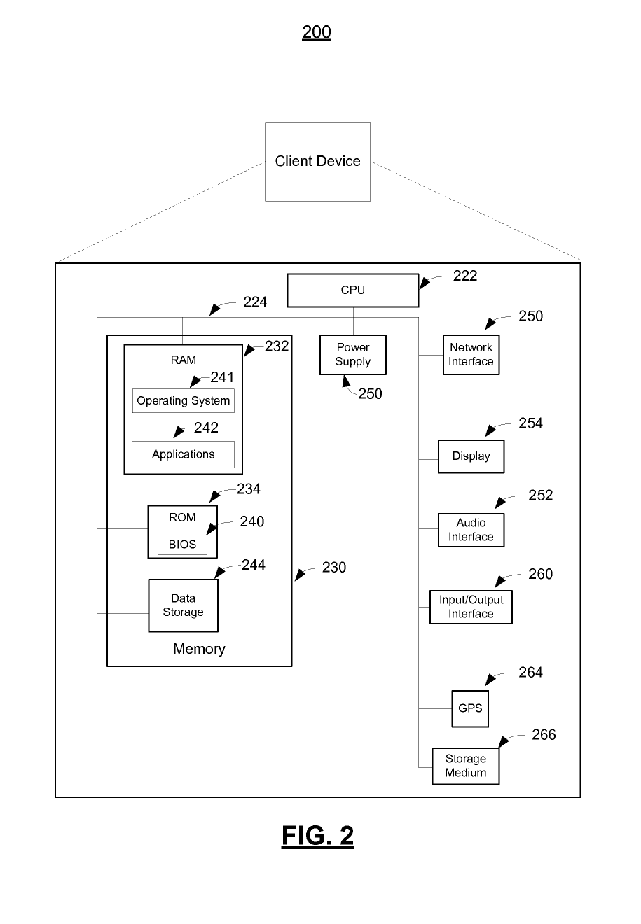

One embodiment of client devices 101-104 is described in more detail below in conjunction with FIG. 2. Generally, however, client devices 101-104 may include virtually any computing device capable of receiving and sending a message over a network, such as network 105, wireless network 110, or the like. Client devices 101-104 may also be described generally as client devices that are configured to be portable or mobile. Thus, client devices 101-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, e-readers, integrated devices combining one or more of the preceding devices, and the like. As such, client devices 101-104 typically range widely in terms of capabilities and features. For example, a cell phone may have a numeric keypad and a few lines of monochrome Liquid Crystal Display (LCD) on which only text may be displayed. In another example, a web-enabled mobile device may have a touch sensitive screen, a stylus, and several lines of color LCD in which both text and graphics may be displayed.

Client devices 101-104 may include devices that typically connect using a wired or wireless communications medium such as personal computers, multiprocessor systems, microprocessor-based or programmable consumer electronics, network Personal Computers (PCs), or the like. In one embodiment at least some of client devices 101-104 may operate over a wired and/or wireless network.

A client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like, to display and send a message. In one embodiment, a user of the client device may employ the browser application to perform various actions over a network (online). However, other applications may also be used to perform various online actions.

For example, client devices 101-104 also may include at least one other client application. The client application may include a capability to provide and receive textual content, graphical content, audio content, and the like. The client application may further provide information that identifies itself, including a type, capability, name, and the like. In one embodiment, client devices 101-104 may uniquely identify themselves through any of a variety of mechanisms, including a phone number, Mobile Identification Number (MIN), an electronic serial number (ESN), or other mobile device identifier. The information may also indicate a content format that the client device is enabled to employ. Such information may be provided in a network packet, or the like, sent between other client devices, servers 107-109, or other computing devices.

Wireless network 110 is configured to couple client devices 102-104 and its components with network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G), 5th (5G) generation radio access for cellular systems, WLAN, Wireless Router (WR) mesh, and the like. Access technologies such as 2G, 3G, 4G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple network devices with other computing devices, including, servers 107-109, client device 101, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within network 105 and wireless network 110. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

Servers 107-109 may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

One or more of servers 107-109 may be configured as, for example a content server, search server, etc. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

FIG. 2 shows one embodiment of client device 200 that may be included in a system implementing the invention. Client device 200 may include more or less components than those shown in FIG. 2. However, the components shown are sufficient to disclose an illustrative embodiment for practicing the present invention. Client device 200 may represent, for example, one embodiment of at least one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, an input/output interface 260, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery. In one embodiment, although not shown, a gyroscope may be employed in client device 200 to measure and/or maintain an orientation of client device 200, and/or an orientation of a displayed image.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), Short Message Service (SMS), general packet radio service (GPRS), WAP, ultra wide band (UWB), IEEE 802.16 Worldwide Interoperability for Microwave Access (WiMax), Session Initiation Protocol/Real-time Transport Protocol (SIP/RTP), or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand. In one embodiment, video interface 259 is configured to enable any of a variety of input/outputs for video digital data over a network.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth®, or the like. Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), Enhanced Observed Time Difference (E-OTD, Cell Identifier (CI), Service Area Identifier (SAI), Enhanced Timing Advance (ETA), Base Station Subsystem (BSS), or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a Media Access Control (MAC) address, IP address, or the like.

Mass memory 230 includes a RAM 232, a ROM 234, and data storage 244. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The memory also stores an operating system 241 for controlling the operation of client device 200. The client device may include or may execute a variety of operating systems, including a personal computer operating system, such as a Windows, iOS or Linux, or a mobile operating system, such as iOS, Android, or Windows Mobile, or the like.

Mass memory 230 further includes one or more data storage 244, which can be utilized by client device 200 to store, among other things, applications, software libraries, and/or other data. For example, data storage 244 may also be employed to store information that describes various capabilities of mobile device 200. The information may then be provided to another device, including being sent as part of a header during a communication, sent upon request, or the like. At least a portion of the data stored on data storage 244 may also be stored on storage medium 266, such as a disk drive, removable storage, or the like within client device 200.

Mass memory 230 and/or storage medium 266 may include a software library in accordance with one embodiment of the invention. The software library is intended to broadly include all programming, applications, algorithms, software and other tools necessary to implement or facilitate methods and systems according to embodiments of the invention. The elements of the software library may exist on a single computer or be distributed among multiple computers or devices.

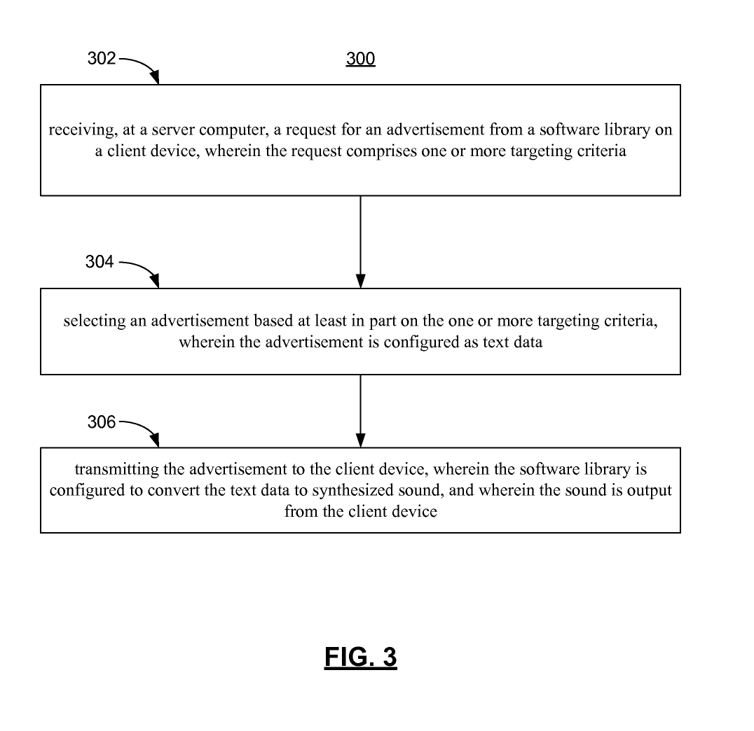

FIG. 3 is a flowchart diagram illustrating a method 300 according to one embodiment of the invention. At step 302, a request for an advertisement may be received at a server computer from a software library on a client device. The request may include one or more targeting criteria. The targeting criteria may be based on behavioral targeting and/or may be based on factors like user preferences, geographic location information, demographics (such as age, gender, etc.), contextual web page content, etc. The user preferences may include for example, language, types of advertisements (e.g., user may specify that he only wants to receive sports related advertisements), etc. In one embodiment, the software library may periodically send requests for advertisements to the server computer (e.g., every hour). The software library may retrieve targeting criteria from the client device, or may retrieve the targeting criteria from a third party source. The software library may transmit the targeting criteria along with the request for an advertisement to the server computer. In another embodiment, the software library may send requests for advertisements to the server computer at predetermined events. For example, a request may be sent when the user is at home, or when the client device is connected to Wi-Fi, etc.

At step 304, an advertisement may be selected based at least in part on the one or more targeting criteria. The advertisement may be configured as text data. In one embodiment, the text data may be encoded using speech synthesis markup language (SSML). In another embodiment, the text data may be plain text data.

At step 306, the advertisement may be transmitted to the client device from the server computer. In one embodiment, the software library is configured to convert the text data to synthesized sound, and the sound is output from the client device. The software library may include a text-to-speech (TTS) software module, which may convert the text data into synthesized sound, and output the sound from, for example speakers on the client device. Transmitting the advertisement(s) as text data advantageously consumes less bandwidth, and does not occupy valuable screen space on the client device. In one embodiment, the software library may display a prompt to obtain the user's permission before playing the synthesized sound. In another embodiment, the software library may also display a pop-up or other notification including a URL associated with the advertisement. The user may click the URL and be directed to the advertiser's website. In another embodiment, the software library may output the synthesized sound at a predetermined time, such as for example, at 8 PM, every night.

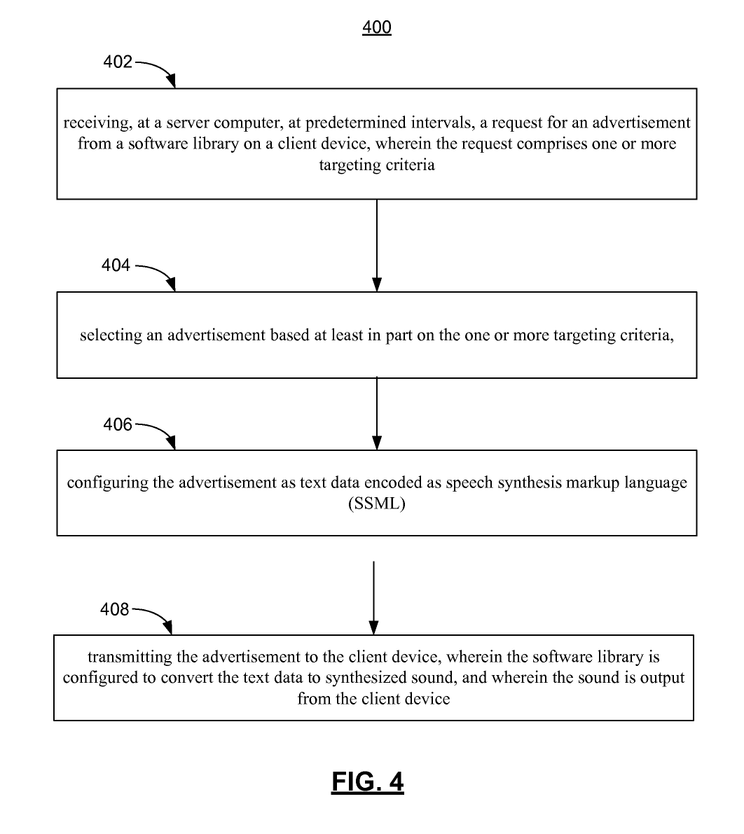

FIG. 4 is a flowchart diagram illustrating a method 400 according to one embodiment of the invention. At step 402, a request for an advertisement may be received at a server computer at predetermined intervals from a software library on a client device. The request may include one or more targeting criteria. The targeting criteria may be based on behavioral targeting and/or may be based on factors like user preferences, geographic location information, demographics (such as age, gender, etc.), contextual web page content, etc. The user preferences may include for example, language, types of advertisements (e.g., user may specify that he only wants to receive sports related advertisements), etc. The software library may retrieve targeting criteria from the client device, or may retrieve the targeting criteria from a third party source. The software library may transmit the targeting criteria along with the request for an advertisement to the server computer.

At step 404, an advertisement may be selected based at least in part on the one or more targeting criteria. At step 406, the advertisement may be configured as text data encoded using speech synthesis markup language (SSML).

At step 408, the advertisement may be transmitted to the client device from the server computer. In one embodiment, the software library is configured to convert the text data to synthesized sound, and the sound is output from the client device. The software library may include a text-to-speech (TTS) software module, which may convert the text data into synthesized sound, and output the sound from, for example speakers on the client device. Transmitting the advertisement(s) as text data advantageously consumes less bandwidth, and does not occupy valuable screen space on the client device. In one embodiment, the software library may display a prompt to obtain the user's permission before playing the synthesized sound. In another embodiment, the software library may also display a pop-up or other notification including a URL associated with the advertisement. The user may click the URL and be directed to the advertiser's website. In another embodiment, the software library may output the synthesized sound at a predetermined time, such as for example, at 8 PM, every night.

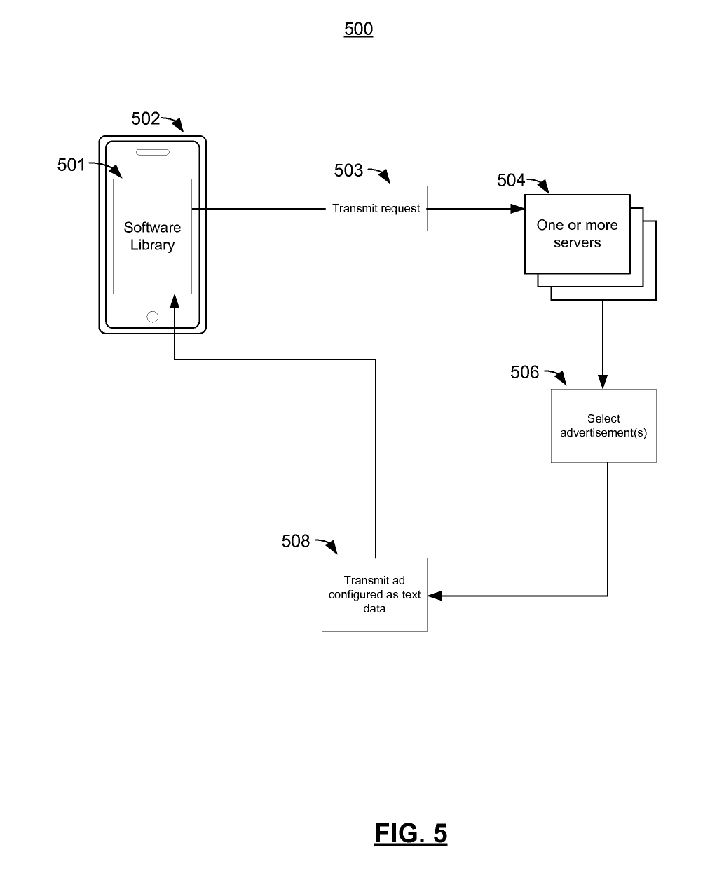

FIG. 5 illustrates a block diagram of a system 500 according to one embodiment of the invention. Client device 502, which may be any one or more of client devices 101-104 (FIG. 1) is depicted. Client device 502 includes a software library 501. As depicted in block 503, software library 501 may transmit, from client device 502, a request for an advertisement to one or more servers 504. Once or more servers may be any one or more of servers 107-109 (FIG. 1). The request may include one or more targeting criteria. The targeting criteria may be based on behavioral targeting and/or may be based on factors like user preferences, geographic location information, demographics (such as age, gender, etc.), contextual web page content, etc. The user preferences may include for example, language, types of advertisements (e.g., user may specify that he only wants to receive sports related advertisements), etc. In one embodiment, the software library may periodically send requests for advertisements to the server computer (e.g., every hour). The software library may retrieve targeting criteria from the client device, or may retrieve the targeting criteria from a third party source. The software library may transmit the targeting criteria along with the request for an advertisement to the server computer. In another embodiment, the software library may send requests for advertisements to the server computer at predetermined events. For example, a request may be sent when the user is at home, or when the client device is connected to Wi-Fi, etc.

As depicted in block 506, one or more servers 504 may select an advertisement based at least in part on the one or more targeting criteria. The advertisement may be configured as text data. In one embodiment, the text data may be encoded using speech synthesis markup language (SSML). In another embodiment, the text data may be plain text data.

As depicted in block 508, the advertisement may be transmitted, from the server computer, to software library 501 on client device 502. In one embodiment, the software library is configured to convert the text data to synthesized sound, and the sound is output from the client device. The software library may include a text-to-speech (TTS) software module, which may convert the text data into synthesized sound, and output the sound from, for example speakers on the client device. Transmitting the advertisement(s) as text data advantageously consumes less bandwidth, and does not occupy valuable screen space on the client device. In one embodiment, the software library may display a prompt to obtain the user's permission before playing the synthesized sound. In another embodiment, the software library may also display a pop-up or other notification including a URL associated with the advertisement. The user may click the URL and be directed to the advertiser's website. In another embodiment, the software library may output the synthesized sound at a predetermined time, such as for example, at 8 PM, every night.

It will be understood that each block of a flowchart illustration need not be limited in the ordering shown in the illustration, and might be performed in any ordering, or even performed concurrently, without departing from the spirit of the invention. It will also be understood that each block of the flowchart illustration, and combinations of blocks in the flowchart illustration, can be implemented by computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

1. A method comprising:
receiving, at a server computer, a request for an advertisement from a software library on a client device, wherein the request comprises one or more targeting criteria;
selecting an advertisement based at least in part on the one or more targeting criteria, wherein the advertisement is configured as text data; and
transmitting the advertisement to the client device, wherein the software library is configured to convert the text data to synthesized sound, and wherein the sound is output from the client device.

2. The method of claim 1, wherein the text data is encoded as Speech Synthesis Markup Language (SSML).

3. The method of claim 1, wherein the one or more targeting criteria include one or more of age, gender, location, and language.

4. The method of claim 1, wherein receiving the request comprises receiving the request at predetermined intervals.

5. The method of claim 1, receiving the request comprises receiving the request at a predetermined event.

6. The method of claim 1, wherein the software library is further configured to display a prompt on the user device to obtain permission from the user before outputting the sound.

7. The method of claim 1, wherein the software library is configured to output the sound at a predetermined time.

8. The method of claim 1, wherein the software library includes a text-to-speech (TTS) converter module.

9. The method of claim 1, wherein the software library is further configured to display a popup including a hyperlink associated with the advertisement.

10. A system comprising:
one or more server computers coupled to a network;
wherein the one or more server computers are for:
receiving a request for an advertisement from a software library on a client device, wherein the request comprises one or more targeting criteria;
selecting an advertisement based at least in part on the one or more targeting criteria, wherein the advertisement is configured as text data; and
transmitting the advertisement to the client device, wherein the software library is configured to convert the text data to synthesized sound, and wherein the sound is output from the client device.

11. The system of claim 10, wherein the text data is encoded as Speech Synthesis Markup Language (SSML).

12. The system of claim 10, wherein the one or more targeting criteria include one or more of age, gender, location, and language.

13. The system of claim 10, wherein receiving the request comprises receiving the request at predetermined intervals.

14. The system of claim 10, receiving the request comprises receiving the request at a predetermined event.

15. The system of claim 10, wherein the software library is further configured to display a prompt on the user device to obtain permission from the user before outputting the sound.

16. The system of claim 10, wherein the software library is configured to output the sound at a predetermined time.

17. The system of claim 10, wherein the software library includes a text-to-speech (TTS) converter module.

18. The system of claim 10, wherein the software library is further configured to display a popup including a hyperlink associated with the advertisement.

19. The system of claim 10, wherein the client device is selected from the group comprising a smart phone, an e-reader, a tablet, a desktop PC, and a laptop PC.

20. A non-transitory computer readable medium having stored thereon instructions for causing a computer to execute a method, the method comprising:
receiving at predetermine intervals, at a server computer, a request for an advertisement from a software library on a client device, wherein the request comprises one or more targeting criteria;
selecting an advertisement based at least in part on the one or more targeting criteria;
configuring the advertisement as text data encoded as speech synthesis markup language (SSML); and
transmitting the advertisement to the client device, wherein the software library is configured to convert the text data to synthesized sound, and wherein the sound is output from the client device.
